(19) United States
(12) Patent Application Publication
(10) Pub. No.: US 2021/0133906 A1
(43) Pub. Date: May 6, 2021

(54) SYSTEMS AND METHODS FOR OBTAINING ROADSIDE ASSISTANCE

(71) Applicant: Toyota Motor North America, Inc., Plano, TX (US)

(72) Inventor: Charan S. Lota, Frisco, TX (US)

(21) Appl. No.: 16/668,420

(22) Filed: Oct. 30, 2019

(51) Int. Cl. G06Q 50/30; G07C 5/08; G07C 5/00; G06Q 30/06; G06Q 10/02

(52) U.S. Cl. CPC G06Q 50/30; G07C 5/0808; G06Q 10/02; G06Q 30/0635; G07C 5/008

(57) ABSTRACT

Systems and methods for obtaining roadside assistance are disclosed herein. One embodiment monitors sensor data from one or more sensors in a vehicle; detects that the vehicle is in a disabled condition based, at least in part, on the monitored sensor data; communicates automatically with a roadside assistance provider to request roadside assistance; communicates automatically with a ridesharing service provider to request a rideshare vehicle; receives roadside assistance availability data from the roadside assistance provider and ridesharing availability data from the ridesharing service provider; analyzes the roadside assistance availability data and the ridesharing availability data; and arranges automatically, with the ridesharing service provider, a pickup time for the rideshare vehicle based, at least in part, on the analysis of the roadside assistance availability data and the ridesharing availability data.

### TECHNICAL FIELD

The subject matter described herein generally relates to vehicles and, more particularly, to systems and methods for obtaining roadside assistance.

### BACKGROUND

Roadside assistance providers have been serving motorists for many years. Ridesharing service providers have, in recent years, become an integral and growing part of the transportation industry. When a motorist experiences a breakdown (e.g., a flat tire), the motorist may contact a roadside assistance provider to come and change the tire or to tow the vehicle to another location where the flat tire can be fixed. If the motorist was en route to an important appointment (e.g., a business meeting), the motorist may also contact a ridesharing service provider to arrange for alternative transportation to the appointment. Making these separate arrangements with a roadside assistance provider and a ridesharing service provider can take precious time, as can arranging to retrieve the vehicle after it has been serviced.

### SUMMARY

An example of a system for obtaining roadside assistance is presented herein. The system comprises one or more vehicle sensors, one or more processors, and a memory communicably coupled to the one or more processors. The memory stores a detection module including instructions that when executed by the one or more processors cause the one or more processors to monitor sensor data from the one or more vehicle sensors and to detect that a vehicle is in a disabled condition based, at least in part, on the monitored sensor data. The memory also stores a response module including instructions that when executed by the one or more processors cause the one or more processors to communicate automatically with a roadside assistance provider to request roadside assistance. The response module also includes instructions to communicate automatically with a ridesharing service provider to request a rideshare vehicle. The response module also includes instructions to receive roadside assistance availability data from the roadside assistance provider and ridesharing availability data from the ridesharing service provider. The response module also includes instructions to arrange automatically, with the ridesharing service provider, a pickup time for the rideshare vehicle based, at least in part, on an analysis of the roadside assistance availability data and the ridesharing availability data.

Another embodiment is a non-transitory computer-readable medium for obtaining roadside assistance and storing instructions that when executed by one or more processors cause the one or more processors to monitor sensor data from one or more sensors in a vehicle. The instructions also cause the one or more processors to detect that the vehicle is in a disabled condition based, at least in part, on the monitored sensor data. The instructions also cause the one or more processors to communicate automatically with a roadside assistance provider to request roadside assistance. The instructions also cause the one or more processors to communicate automatically with a ridesharing service provider to request a rideshare vehicle. The instructions also cause the one or more processors to receive roadside assistance availability data from the roadside assistance provider and ridesharing availability data from the ridesharing service provider. The instructions also cause the one or more processors to arrange automatically, with the ridesharing service provider, a pickup time for the rideshare vehicle based, at least in part, on an analysis of the roadside assistance availability data and the ridesharing availability data.

In another embodiment, a method of obtaining roadside assistance is disclosed. The method comprises monitoring sensor data from one or more sensors in a vehicle. The method also includes detecting that the vehicle is in a disabled condition based, at least in part, on the monitored sensor data. The method also includes communicating automatically with a roadside assistance provider to request roadside assistance. The method also includes communicating automatically with a ridesharing service provider to request a rideshare vehicle. The method also includes receiving roadside assistance availability data from the roadside assistance provider and ridesharing availability data from the ridesharing service provider. The method also includes analyzing the roadside assistance availability data and the ridesharing availability data. The method also includes arranging automatically, with the ridesharing service provider, a pickup time for the rideshare vehicle based, at least in part, on the analyzing the roadside assistance availability data and the ridesharing availability data.

### BRIEF DESCRIPTION OF THE DRAWINGS

So that the manner in which the above-recited features of the present disclosure can be understood in detail, a more particular description of the disclosure, briefly summarized above, may be had by reference to the implementations, some of which are illustrated in the appended drawings. It is to be noted, however, that the appended drawings illustrate only possible implementations of this disclosure and are therefore not to be considered limiting of its scope. The disclosure may admit to other implementations.

FIG. 1 illustrates one embodiment of a vehicle within which systems and methods disclosed herein may be implemented.

FIG. 2 illustrates one embodiment of roadside assistance system.

FIG. 3 is a flowchart of a method of obtaining roadside assistance, in accordance with an illustrative embodiment of the invention.

To facilitate understanding, identical reference numerals have been used, wherever possible, to designate identical elements that are common to the figures. Additionally, elements of one or more embodiments may be advantageously adapted for utilization in other embodiments described herein. In some drawings, the abbreviation “RA” is used to denote “roadside assistance,” and the abbreviation “RS” is used to denote “ridesharing.”

### DETAILED DESCRIPTION

In various embodiments described herein, automation and intelligent computerized decision making are applied to vehicle malfunctions and breakdowns that lead motorists to seek roadside assistance and, in some situations, alternative transportation such as ridesharing. One aspect of the embodiments described herein is vehicle sensors that enable an automated roadside assistance system in the vehicle to detect when a vehicle is in a disabled condition (e.g., the vehicle has a flat tire, is out of fuel, has a dead battery, etc.). Another aspect of the embodiments described herein is that the roadside assistance system, in response to detecting a disabled condition, can communicate automatically with a roadside assistance provider to request roadside assistance and with a ridesharing service provider to request a rideshare vehicle. In some embodiments, the vehicle sensors can also determine the extent of damage to the vehicle, if any, associated with the disabled condition. In those embodiments, the roadside assistance system can automatically report the extent of the damage to the roadside assistance provider.

Another aspect of the embodiments described herein is that the roadside assistance system can receive data regarding the availability of roadside assistance and the availability of ridesharing. In embodiments, the roadside assistance system analyzes such data to determine when a roadside-assistance vehicle (e.g., a tow truck) is likely to arrive and when a rideshare vehicle can pick up vehicle occupants to transport them to their intended destination. In some embodiments, if the rideshare vehicle is expected to arrive before the tow truck or other maintenance vehicle, the roadside assistance system can automatically transmit a digital key to the roadside assistance provider to permit, e.g., a tow-truck driver to access the locked vehicle temporarily after the motorist has left the scene of the breakdown in a rideshare vehicle.

Another aspect of the embodiments described herein is that the roadside assistance system can facilitate delivery of a vehicle to its owner or a user after it has been repaired. In some embodiments, the roadside assistance system transmits, to the roadside assistance provider, a digital key providing temporary access to a garage associated with the owner or user to permit an agent of the roadside assistance provider, when delivering the vehicle, to park the vehicle inside the secured garage. Additionally, in some embodiments, the roadside assistance system can automatically notify the owner or user (e.g., via text or e-mail) when the vehicle has been delivered.

Various aspects of the embodiments described herein, such as those discussed above and others to be described below, can be combined in various ways to reduce the inconvenience, to a motorist, of a vehicle breakdown. In embodiments, the roadside assistance system can provide a motorist with an enhanced “white-glove” roadside-assistance experience.

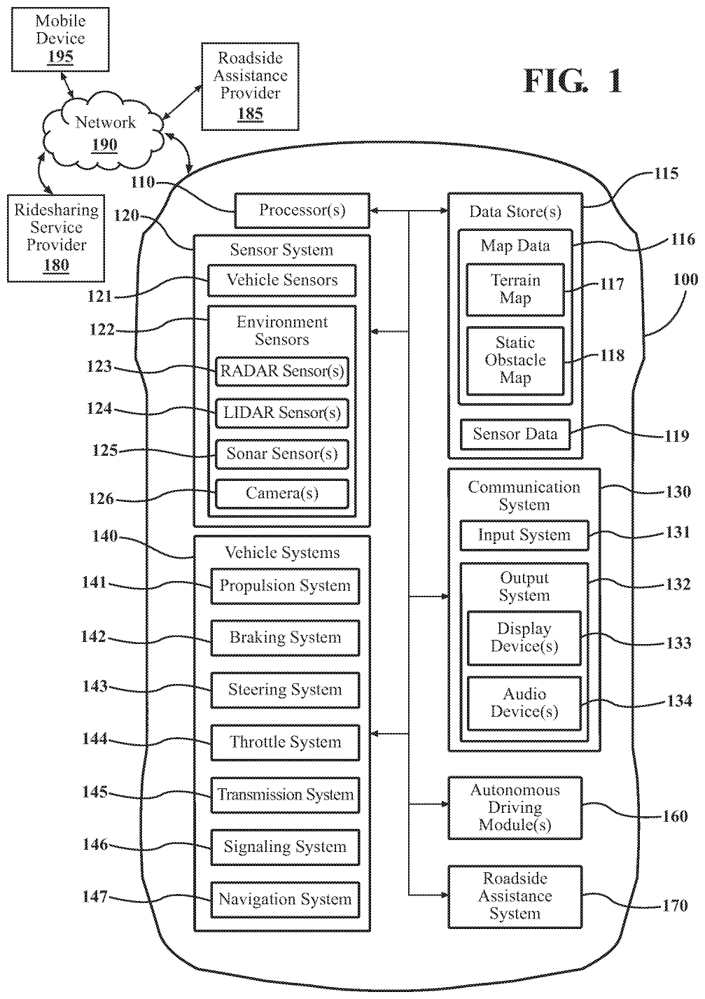

Referring to FIG. 1, an example of a vehicle 100, in which systems and methods disclosed herein can be implemented, is illustrated. The vehicle 100 can include a roadside assistance system 170 or components and/or modules thereof. As used herein, a “vehicle” is any form of motorized transport. In one or more implementations, the vehicle 100 can be an automobile. In some implementations, the vehicle 100 may be any other form of motorized transport. In some embodiments, vehicle 100 is capable of operating in a semi-autonomous or fully autonomous mode. The vehicle 100 can include the roadside assistance system 170 or capabilities to support or interact with the roadside assistance system 170 and thus benefits from the functionality discussed herein. While arrangements will be described herein with respect to automobiles, it will be understood that implementations are not limited to automobiles. Instead, implementations of the principles discussed herein can be applied to any kind of vehicle, as discussed above. Instances of vehicle 100, as used herein, are equally applicable to any device capable of incorporating the systems or methods described herein.

The vehicle 100 also includes various elements. It will be understood that, in various implementations, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1, including roadside assistance system 170. While the various elements are shown as being located within the vehicle 100 in FIG. 1, it will be understood that one or more of these elements can be located external to the vehicle 100. Further, the elements shown may be physically separated by large distances. As shown in FIG. 1, vehicle 100 may communicate with one or more of a ridesharing service provider 180, a roadside assistance provider 185, and a user's mobile device 195 via network 190.

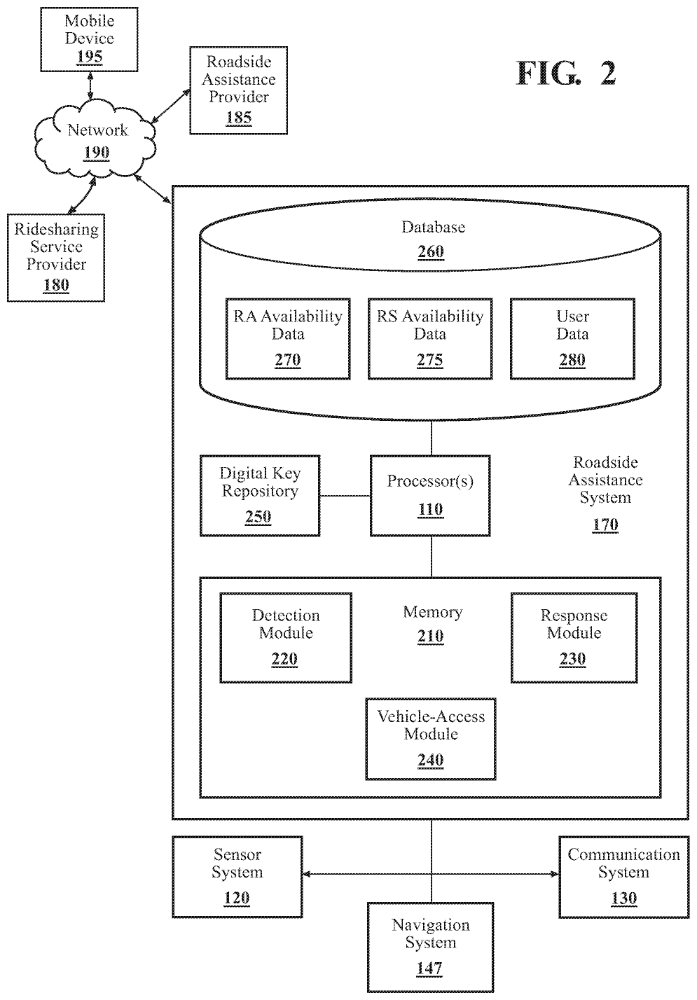

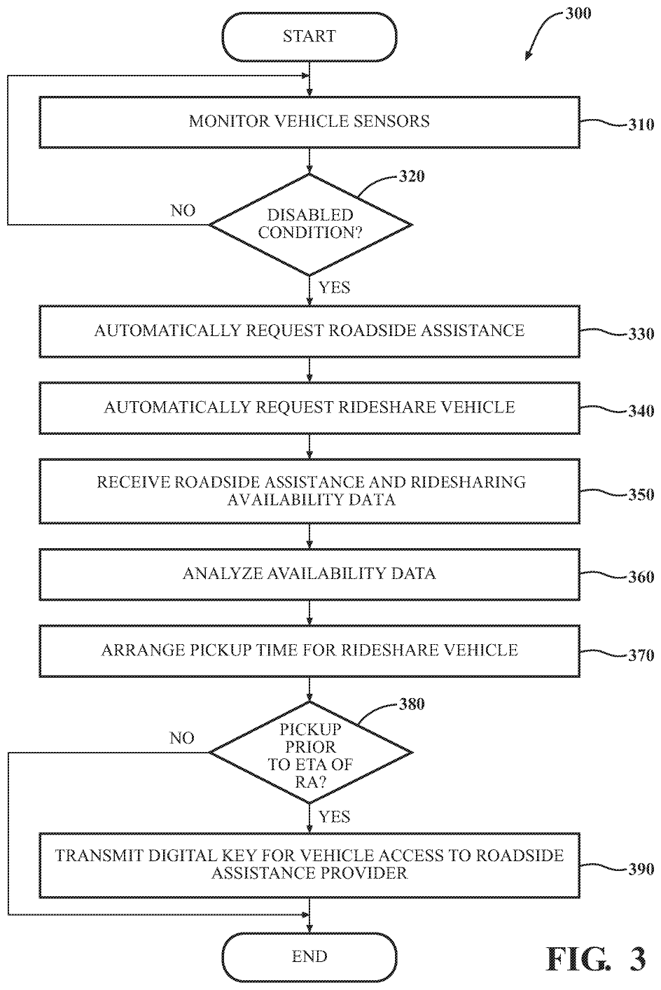

Some of the possible elements of the vehicle 100 are shown in FIG. 1 and will be described in connection with subsequent figures. However, a description of many of the elements in FIG. 1 will be provided after the discussion of FIGS. 2-3 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those skilled in the art, however, will understand that the embodiments described herein may be practiced using various combinations of these elements.

Sensor system 120 can include one or more vehicle sensors 121. Vehicle sensors 121 can include one or more positioning systems such as a dead-reckoning system, a global navigation satellite system (GNSS), or a global positioning system (GPS). Vehicle sensors 121 can also include sensors to detect malfunctions or breakdowns in various components and systems of vehicle 100. Sensor system 120 can also include one or more environment sensors 122. Environment sensors 122 can include RADAR sensor(s) 123, LIDAR sensor(s) 124, sonar sensor(s) 125, and camera(s) 126.

Referring to FIG. 2, one embodiment of the roadside assistance system 170 of FIG. 1 is further illustrated. In this embodiment, roadside assistance system 170 is shown as including one or more processors 110 from the vehicle 100 of FIG. 1. In general, the one or more processors 110 may be a part of roadside assistance system 170, roadside assistance system 170 may include one or more separate processors from the one or more processors 110 of the vehicle 100, or roadside assistance system 170 may access the one or more processors 110 through a data bus or another communication path, depending on the embodiment.

In one embodiment, memory 210 stores a detection module 220, a response module 230, and a vehicle-access module 240. The memory 210 is a random-access memory (RAM), read-only memory (ROM), a hard-disk drive, a flash memory, or other suitable memory for storing the modules 220, 230, and 240. The modules 220, 230, and 240 are, for example, computer-readable instructions that when executed by the one or more processors 110, cause the one or more processors 110 to perform the various functions disclosed herein.

As shown in FIG. 2, roadside assistance system 170 can communicate with one or more of a ridesharing service provider 180, a roadside assistance provider 185, and a user's mobile device 195 via network 190. Examples of a mobile device 195 include, without limitation, a cellular telephone, a smartphone, a personal digital assistant, a tablet computer, and a laptop computer. In some embodiments, roadside assistance system 170 communicates and interacts with sensor system 120, communication system 130, and navigation system 147 of vehicle 100 (refer to FIG. 1).

Detection module 220 generally includes instructions that cause the one or more processors 110 to monitor sensor data from one or more vehicle sensors. The one or more vehicle sensors can include any combination of the vehicle sensors 121 and environment sensors 122 discussed above. Detection module 220 also includes instructions that cause the one or more processors 110 to detect that a vehicle 100 is in a disabled condition based, at least in part, on the monitored sensor data. Herein, the term “disabled condition” refers to a condition in which (1) vehicle 100 has experienced a malfunction or breakdown of sufficient magnitude to render vehicle 100 undrivable, or (2) vehicle 100 has experienced a malfunction or breakdown such that driving vehicle 100 further in its present condition risks causing serious and possibly permanent damage to vehicle 100. In the first case, vehicle 100 is likely to come to a stop within a short distance, and it might not be possible to park vehicle 100 in a chosen location. In the second case, it might be possible to drive vehicle 100 a short distance further and to park vehicle 100 on the shoulder of a roadway or in a nearby parking lot.

Some examples of a disabled condition include, without limitation, a flat tire, a dead battery, being out of fuel, a major engine failure, a braking-system failure, a steering-system failure, a broken timing belt, and a cooling-system malfunction causing the engine to overheat. In the absence of roadside assistance system 170, such a disabled condition might prompt the driver or other vehicle occupant to seek roadside assistance and/or ridesharing service manually by, e.g., placing one or more phone calls. As discussed further below, roadside assistance system 170 automates obtaining both roadside assistance and a ridesharing vehicle.

In general, detection module 220 can detect that vehicle 100 is in a disabled condition based on the monitored sensor data and, in some embodiments, on one or more additional inputs. For example, in one embodiment relying on monitored sensor data, detection module 220 detects, via certain vehicle sensors 121, that vehicle 100 has a flat tire and correlates that information with data from other vehicle sensors 121 (e.g., a positioning system) indicating that vehicle 100 is currently parked on the shoulder of a highway (an abnormal location for vehicle 100 to be parked). From the correlated sensor information (flat tire and abnormal parked location), detection module 220 can infer that vehicle 100 is in a disabled condition.

The foregoing example generalizes to a variety of other cases in which detection module 220 can correlate one or more detected vehicle-system or component malfunctions or failures with vehicle 100 being parked in an abnormal or unexpected location. In some embodiments, determining that vehicle 100 is parked in an abnormal location can be based, in part, on a vehicle occupant's on-line calendar data containing the times and locations of the vehicle occupant's appointments. In such an embodiment, detection module 220 can access the vehicle occupant's on-line calendar data by communicating with the vehicle occupant's mobile device 195. As mentioned above, in some embodiments, the vehicle occupant may be the driver of vehicle 100, or, if vehicle 100 is an autonomous vehicle, the vehicle occupant may be a passenger riding in vehicle 100.

In other embodiments, detection module 220 can analyze other sensor data such as video and/or audio of vehicle occupants to detect automatically that vehicle 100 is in a disabled condition. This analysis can include recognizing words of speech indicating a malfunction or breakdown and/or detecting a vehicle occupant's actions (e.g., attempting to start vehicle 100 without success) and emotional state (stressed, angry, frustrated, etc.), depending on the embodiment. As the above examples illustrate, detection module 220 can analyze a variety of different kinds of sensor data to infer that vehicle 100 is in a disabled condition.

In some embodiments, detecting that vehicle 100 is in a disabled condition can be based on other inputs in addition to the monitored sensor data. For example, in one embodiment, detection module 220 detects a vehicle malfunction or breakdown via vehicle sensors 121 and additionally receives, via a user interface, an explicit request to activate the automated services of roadside assistance system 170 from an occupant of vehicle 100. In this embodiment, the combination of the sensed malfunction and the vehicle occupant's explicit request for assistance constitutes a “disabled condition” (a condition triggering automated requests for roadside assistance and a rideshare vehicle).

In some cases, detection module 220 may be unable to detect a disabled condition based, in part, on vehicle 100 being parked in an abnormal or unusual location. For example, a vehicle 100 might break down while parked in the owner's garage or driveway or at the owner's workplace. In such as case, detection module 220 can analyze other sensor data to infer that vehicle 100 is in a disabled condition. Such other sensor data could include, as discussed above, user on-line calendar data and/or data pertaining to the user's actions, behavior, and emotional state (e.g., video and/or audio of vehicle occupants). Additionally, in such a situation, a vehicle owner or user can, in some embodiments, input an explicit command to initiate the automated services of roadside assistance system 170 via a user interface, as discussed above. Detection module 220 can correlate such an input with a detected malfunction or breakdown in vehicle 100, as discussed above.

Response module 230 generally includes instructions that cause the one or more processors 110 to communicate automatically with a roadside assistance provider 185 to request roadside assistance and to communicate automatically with a ridesharing service provider 180 to request a rideshare vehicle. Response module 230 also includes instructions that cause the one or more processors 110 to receive availability data for roadside assistance (RA availability data 270) from the roadside assistance provider 185 and availability data for ridesharing (RS availability data 275) from the ridesharing service provider 180. Further, response module 230 includes instructions that cause the one or more one or more processors 110 to arrange automatically, with the ridesharing service provider 180, a pickup time for a rideshare vehicle based, at least in part, on an analysis of the roadside assistance availability data 270 and the ridesharing availability data 275. Response module 230 performs these tasks in response to detection module 220 detecting that vehicle 100 is in a disabled condition, as discussed above.

In communicating automatically with roadside assistance provider 185 and ridesharing service provider 180, response module 230 can use communication system 130 of vehicle 100 to communicate via network 190 with, for example, a server or portal associated with roadside assistance provider 185 and a server or portal associated with ridesharing service provider 180 in accordance with protocols agreed upon in advance between the manufacturer of vehicle 100 and the service providers. In a different embodiment, response module 230 can communicate with roadside assistance provider 185 and/or ridesharing service provider 180 via automated phone calls containing computer-generated speech. In communicating with roadside assistance provider 185 or ridesharing service provider 180 over network 190, response module 230 can use, e.g., a cellular data, cellular voice, or WiFi connection, depending on the embodiment.

As discussed above, in some embodiments, response module 230 includes instructions to receive roadside assistance availability data 270 from the roadside assistance provider 185 and ridesharing availability data 275 from the ridesharing service provider 180. The roadside assistance availability data 270 can, for example, indicate to response module 230 an estimated time of arrival (ETA), at the location of the breakdown, of a tow truck or other service vehicle. The ridesharing availability data 275 can, for example, include information regarding the availability of rideshare vehicles in the vicinity of vehicle 100 and the estimated pickup time, at the breakdown location, for each potential rideshare vehicle. Response module 230 can automatically hail a rideshare vehicle based on predetermined user preferences or other criteria. Roadside assistance system 170 can store user preferences and other user-related data in user data 280 (see database 260 in FIG. 2).

In general, response module 230 can arrange automatically, with the ridesharing service provider 180, a pickup time for a selected rideshare vehicle based, at least in part, on an analysis of the roadside assistance availability data 270 and the ridesharing availability data 275. In some embodiments, response module 230 favors (prefers) an arrangement under which the rideshare vehicle arrives at the location of the breakdown prior to the tow truck or other service vehicle. This permits the occupants of vehicle 100 to proceed with their trip as quickly as possible in the rideshare vehicle without having to wait for the tow truck or other service vehicle, improving the likelihood that the occupants of vehicle 100 will make it to an important meeting or appointment. In such cases, vehicle-access module 240 can, in some embodiments, transmit a temporary digital key to roadside assistance provider 185 to permit an agent of the roadside assistance provider 185 (e.g., a tow-truck driver) to access vehicle 100, as discussed further below. Knowing the ETA of the tow truck or other maintenance vehicle permits response module 230 to look for a rideshare vehicle that will arrive before that time. In other embodiments, response module 230 schedules the rideshare vehicle to pick up the occupant(s) of vehicle 100 at a time later than the ETA of roadside assistance, either because no rideshare vehicle is available prior to that time or for another reason (e.g., user preference, lack of a digital key system, etc.).

In some embodiments, response module 230 includes instructions to assess the extent of damage, if any, associated with the vehicle's disabled condition and to report that information to roadside assistance provider 185. Response module 230 can assess the damage based, at least in part, on sensor data from vehicle sensors 121 and/or environment sensors 122.

In some embodiments, response module 230 includes instructions to ascertain the intended destination of vehicle 100 (had the breakdown not occurred) and to specify the intended destination in the request for a rideshare vehicle. In one embodiment, response module 230 obtains the intended destination by consulting the navigation system 147 of vehicle 100. If a destination was input to navigation system 147 during the relevant timeframe and was active in navigation system 147 at the time the disabled condition appeared, that destination can be used by response module 230 in requesting a rideshare vehicle. In another embodiment, response module 230 obtains the intended destination by consulting a user's on-line (electronic) calendar data, as discussed above. For example, a calendar entry may contain the address of a meeting or other appointment to which the driver was en route before the disabled condition appeared. In some embodiments, response module 230 includes instructions to confirm with a user that an inferred intended destination is correct before automatically contacting a ridesharing service provider 180. This can be done advantageously through computer-generated speech via audio device(s) 134 of vehicle 100. In some embodiments, such confirmation can apply to any of the automated actions that the modules of roadside assistance system 170 perform.

In some embodiments, response module 230 includes instructions to send an automated notification (e.g., e-mail or text message) to one or more meeting participants listed in a user's on-line calendar entry. Such a notification can, for example, notify the recipients that the user has been delayed due to a vehicle breakdown. In some cases, the notification can include the user's estimated time of arrival at the meeting or appointment based on the expected drop-off time of a requested rideshare vehicle transporting the user from the breakdown location to the meeting or appointment.

In some embodiments, response module 230 includes instructions to detect, from sensor data, the number of occupants in vehicle 100. For example, response module 230 can analyze video from one or more cameras in the interior passenger compartment of vehicle 100 to determine how many occupants are in vehicle 100. In other embodiments, response module 230 may base the occupant count, at least in part, on weight sensors in the vehicle's seats. In some embodiments, response module 230, in communicating automatically with a ridesharing service provider 180, can request a rideshare vehicle of the appropriate type to accommodate the number of occupants in vehicle 100. For example, if response module 230 determines that there are seven occupants in vehicle 100, response module 230 might specifically request a mini-van or SUV from ridesharing service provider 180.

In some embodiments, roadside assistance system 170 automatically facilitates delivery of vehicle 100 to an owner or user of the vehicle after it has been repaired. In those embodiments, response module 230 also includes instructions to transmit an automated notification to an owner or other user of vehicle 100 that vehicle 100 has been delivered. Other aspects of this feature are discussed below in connection with vehicle-access module 240.

In some embodiments, vehicle 100 includes a digital key system to control access to vehicle 100. In one embodiment, when the owner or another authorized user in possession of a digital key approaches vehicle 100, an app on the user's mobile device 195 communicates with an access-control system (e.g., vehicle-access module 240 in FIG. 2) in vehicle 100. Once the access-control system has verified that the user's digital key matches that stored in a hardware digital key repository 250 in vehicle 100, the access-control system unlocks the vehicle to admit the user. In one embodiment, the user's mobile device 195 communicates with the access-control system via a Bluetooth Low-Energy (BLE) connection. In some embodiments, the administration of digital keys is conducted in the cloud by one or more servers. When a digital key is to be granted to a user, the cloud server transmits the digital key over a secure channel to the digital key repository 250 in vehicle 100 mentioned above. The cloud server also transmits the digital key to the digital-key recipient's mobile device 195. In some cases, a digital key can be granted to a user temporarily. Such a digital key can be made to expire when specified conditions have been satisfied (e.g., the passage of a predetermined period of time). In some embodiments, the owner of the vehicle retains a master digital key that does not expire unless the vehicle is sold or otherwise disposed of.

Vehicle-access module 240 generally includes instructions that cause the one or more processors 110 to transmit, to the roadside assistance provider 185, a digital key providing temporary access to vehicle 100, when the arranged pickup time for the rideshare vehicle is prior to the ETA of roadside assistance. As mentioned above, such a digital key can provide an agent of the roadside assistance provider 185 (e.g., a tow-truck driver or other maintenance worker) with temporary access to locked vehicle 100 (e.g., to prepare vehicle 100 for towing).

Depending on the embodiment, the temporary digital key can be made to expire in different ways. In one embodiment, the digital key expires a specified period of time (e.g., 48 hours) after the roadside assistance provider 185 receives the digital key from vehicle-access module 240. In another embodiment, the digital key expires when an agent of the roadside assistance provider 185 delivering vehicle 100 to a specified location after vehicle 100 has been serviced exits a predetermined geofence surrounding the specified location (e.g., the location of the vehicle owner's original intended destination before the breakdown, the vehicle owner's home, or the vehicle owner's workplace). For example, vehicle-access module 240 can communicate with a mobile device 195 belonging to the agent delivering the vehicle to detect when the agent has left the boundaries of the predetermined geofence. In some embodiments, vehicle-access module 240 combines the two conditions for expiration of the digital key (e.g., the digital key expires with the occurrence of the earliest of the two events).

As discussed above, in some embodiments, roadside assistance system 170 can facilitate delivery of vehicle 100 to its owner or other authorized user after it has been serviced or repaired. In those embodiments, response module 230 includes instructions to communicate with the roadside assistance provider 185 to negotiate or arrange for delivery. Those arrangements can include a specified location for delivery. In some embodiments, vehicle-access module 240 includes instructions to transmit, to the roadside assistance provider 185, a digital key providing temporary access to a garage associated with a user of vehicle 100 to permit an agent of the roadside assistance provider 185 delivering vehicle 100 after the vehicle has been serviced to park the vehicle inside the garage. Such a digital key can be administered in a manner similar to that described above for digital keys to vehicle 100. That is, the digital key can be issued by a backend cloud-based system, and the user can access the garage using an app on a mobile device 195. The temporary digital key to the garage can be made to expire in a manner similar to that described above for digital keys to vehicle 100.

FIG. 3 is a flowchart of a method 300 of presenting virtual-reality information in a vehicular environment, in accordance with an illustrative embodiment of the invention. Method 300 will be discussed from the perspective of roadside assistance system 170 in FIG. 2. While method 300 is discussed in combination with roadside assistance system 170, it should be appreciated that method 300 is not limited to being implemented within roadside assistance system 170, but roadside assistance system 170 is instead one example of a system that may implement method 300. Note that blocks 380 and 390 are not present in all embodiments.

At block 310, detection module 220 monitors one or more vehicle sensors in sensor system 120, which can include any combination of vehicle sensors 121 and environment sensors 122, as discussed above.

At block 320, if detection module 220 detects that vehicle 100 is in a disabled condition, control proceeds to block 330. Otherwise, detection module 220 continues to monitor the one or more vehicle sensors at block 310. As discussed above, detection module 220 can detect that vehicle 100 is in a disabled condition based on the monitored sensor data and, in some embodiments, on one or more additional inputs (e.g., an explicit input from a user requesting assistance from roadside assistance system 170).

At block 330, response module 230 communicates automatically with a roadside assistance provider 185 to request roadside assistance (e.g., a tow truck or other service vehicle). As discussed above, in some embodiments, that request can include information regarding the extent of damage to vehicle 100 associated with the disabled condition based, at least in part, on sensor data.

At block 340, response module 230 communicates automatically with a ridesharing service provider 180 to request a rideshare vehicle. As discussed above, in some embodiments, response module 230, after ascertaining the intended destination of vehicle 100 prior to the breakdown, specifies, to the ridesharing service provider 180, the intended destination as the destination for the requested rideshare vehicle. This permits the occupants of vehicle 100 to proceed to a destination where they might, for example, have an important meeting or appointment.

At block 350, response module 230 receives roadside assistance availability data 270 from the roadside assistance provider 185 and ridesharing availability data 275 from the ridesharing service provider 180. As discussed above, the roadside assistance availability data 270 can, for example, indicate to response module 230 an ETA, at the location of the breakdown, of a tow truck or other service vehicle. The ridesharing availability data 275 can, for example, include information regarding the availability of rideshare vehicles in the vicinity of vehicle 100 and the estimated pickup time, at the breakdown location, for each potential rideshare vehicle.

At block 360, response module 230 analyzes the roadside assistance availability data 270 and the ridesharing availability data 275. In some embodiments, this can include correlating or comparing the ETA of roadside assistance with available pickup times for one or more potential rideshare vehicles, as discussed above.

At block 370, response module 230 arranges automatically, with the ridesharing service provider 180, a pickup time for a specific selected rideshare vehicle based, at least in part, on the analysis of the roadside assistance availability data 270 and the ridesharing availability data 275. As explained above, in some embodiments, response module 230 is configured to prefer an arrangement under which the rideshare vehicle arrives before roadside assistance to enable occupants of vehicle 100 to proceed with their trip as quickly as possible. In other embodiments, response module 230 arranges for a pickup time for the rideshare vehicle that is later than the ETA of roadside assistance. The choice of rideshare-vehicle pickup time relative to the ETA of roadside service can depend on factors such as user preferences and can be dynamic (e.g., dependent on the availability of ridesharing vehicles and other situational factors).

At block 380, if the arranged pickup time for the rideshare vehicle is prior to the ETA of roadside assistance, vehicle-access module 240 transmits, to the roadside assistance provider 185, a digital key providing temporary access to vehicle 100 at block 390, as discussed above.

In other embodiments, method 300 can be expanded to include additional tasks. For example, in some embodiments, response module 230 includes instructions to send an automated notification (e.g., e-mail or text message) to one or more meeting participants listed in a user's on-line calendar entry. Such a notification can, for example, notify the recipients that the user has been delayed due to a vehicle breakdown. In some cases, the notification can include the user's estimated time of arrival at the meeting or appointment based on the expected drop-off time of a reserved rideshare vehicle transporting the user from the breakdown location to the meeting or appointment.

In another embodiment, response module 230 includes instructions to detect the number of occupants in vehicle 100 from the sensor data, as discussed above. In those embodiments, response module 230, in communicating with the ridesharing service provider 180, can request that the hailed rideshare vehicle be of a type that can accommodate the detected number of occupants.

In some embodiments, response module 230 includes instructions to report, to the roadside assistance provider 185, the extent of damage to vehicle 100 associated with the vehicle's disabled condition based, at least in part, on the sensor data, as discussed above. Response module 230 can do this in connection with the initial request for roadside assistance to enable the roadside assistance provider 185 to send a tow truck or other service vehicle that is properly equipped to address the particular cause of the disabled condition of vehicle 100.

In some embodiments, vehicle-access module 240 includes instructions to transmit, to the roadside assistance provider 185, a digital key providing temporary access to a garage associated with a user of vehicle 100 to permit an agent of the roadside assistance provider 185 delivering vehicle 100 after it has been serviced to park it inside the garage, as discussed above. In some embodiments, response module 230 also includes instructions to transmit an automated notification to the owner or user of vehicle 100 informing the owner or user that vehicle 100 has been delivered, as discussed above.

FIG. 1 will now be discussed in full detail as an example vehicle environment within which the systems and methods disclosed herein may be implemented. In some instances, the vehicle 100 can be configured to switch selectively between an autonomous mode, one or more semi-autonomous operational modes, and/or a manual mode. Such switching, also referred to as handover when transitioning to a manual mode, can be implemented in a suitable manner, now known or later developed. “Manual mode” means that all of or a majority of the navigation and/or maneuvering of the vehicle is performed according to inputs received from a user (e.g., human driver/operator).

In one or more implementations, the vehicle 100 can be an autonomous vehicle. As used herein, “autonomous vehicle” refers to a vehicle that operates in an autonomous mode. “Autonomous mode” refers to navigating and/or maneuvering a vehicle along a travel route using one or more computing devices to control the vehicle with minimal or no input from a human driver/operator. In one implementation, the vehicle 100 is configured with one or more semi-autonomous operational modes in which one or more computing devices perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route. Thus, in one or more implementations, the vehicle 100 operates autonomously according to a particular defined level of autonomy.

The vehicle 100 can include one or more processors 110. In one or more arrangements, the one or more processors 110 can be a main processor of the vehicle 100. For instance, the one or more processors 110 can be an electronic control unit (ECU). The vehicle 100 can include one or more data stores 115 for storing one or more types of data. The data store(s) 115 can include volatile and/or non-volatile memory. Examples of suitable data stores 115 include RAM, flash memory, ROM, PROM (Programmable Read-Only Memory), EPROM, EEPROM (Electrically Erasable Programmable Read-Only Memory), registers, magnetic disks, optical disks, hard drives, or any other suitable storage medium, or any combination thereof. The data store(s) 115 can be a component(s) of the one or more processors 110, or the data store(s) 115 can be operatively connected to the one or more processors 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. In one or more arrangement, the map data 116 can include one or more terrain maps 117. The terrain map(s) 117 can include information about the ground, terrain, roads, surfaces, and/or other features of one or more geographic areas. In one or more arrangement, the map data 116 can include one or more static obstacle maps 118. The static obstacle map(s) 118 can include information about one or more static obstacles located within one or more geographic areas.

The one or more data stores 115 can include sensor data 119. In this context, “sensor data” means any information about the sensors that a vehicle is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120. As discussed above, in some embodiments, vehicle 100 can receive sensor data from other connected vehicles, from devices associated with ORUs, or both.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can function independently from each other. Alternatively, two or more of the sensors can work in combination with each other. In such a case, the two or more sensors can form a sensor network. The sensor system 120 and/or the one or more sensors can be operatively connected to the one or more processors 110, the data store(s) 115, and/or another element of the vehicle 100 (including any of the elements shown in FIG. 1).

The sensor system 120 can include any suitable type of sensor. Various examples of different types of sensors will be described herein. However, it will be understood that the implementations are not limited to the particular sensors described. The sensor system 120 can include one or more vehicle sensors 121. The vehicle sensors 121 can detect, determine, and/or sense information about the vehicle 100 itself, including the operational status of various vehicle components and systems. That is, vehicle sensors 121 can detect malfunctions or breakdowns in various vehicle components and systems.

In one or more arrangements, the vehicle sensors 121 can be configured to detect, and/or sense position and/orientation changes of the vehicle 100, such as, for example, based on inertial acceleration. In one or more arrangements, the vehicle sensors 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensors 121 can be configured to detect, and/or sense one or more characteristics of the vehicle 100. In one or more arrangements, the vehicle sensors 121 can include a speedometer to determine a current speed of the vehicle 100.

Alternatively, or in addition, the sensor system 120 can include one or more environment sensors 122 configured to acquire, and/or sense driving environment data. “Driving environment data” includes any data or information about the external environment in which a vehicle is located or one or more portions thereof. For example, the one or more environment sensors 122 can be configured to detect, quantify, and/or sense obstacles in at least a portion of the external environment of the vehicle 100 and/or information/data about such obstacles. The one or more environment sensors 122 can be configured to detect, measure, quantify, and/or sense other things in at least a portion the external environment of the vehicle 100, such as, for example, nearby vehicles, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. Moreover, the sensor system 120 can include operator sensors that function to track or otherwise monitor aspects related to the driver/operator of the vehicle 100. However, it will be understood that the implementations are not limited to the particular sensors described. As an example, in one or more arrangements, the sensor system 120 can include one or more radar sensors 123, one or more LIDAR sensors 124, one or more sonar sensors 125, and/or one or more cameras 126.

The vehicle 100 can further include a communication system 130. The communication system 130 can include one or more components configured to facilitate communication between the vehicle 100 and one or more communication sources. Communication sources, as used herein, refers to people or devices with which the vehicle 100 can communicate with, such as external networks, computing devices, operator or occupants of the vehicle 100, or others. As part of the communication system 130, the vehicle 100 can include an input system 131. An “input system” includes any device, component, system, element or arrangement or groups thereof that enable information/data to be entered into a machine. In one or more examples, the input system 131 can receive an input from a vehicle occupant (e.g., a driver or a passenger). The vehicle 100 can include an output system 132. An “output system” includes any device, component, or arrangement or groups thereof that enable information/data to be presented to the one or more communication sources (e.g., a person, a vehicle passenger, etc.). The communication system 130 can further include specific elements which are part of or can interact with the input system 131 or the output system 132, such as one or more display device(s) 133, and one or more audio device(s) 134 (e.g., speakers and microphones).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or combinations thereof, now known or later developed.

The one or more processors 110 and/or the autonomous driving module(s) 160 can be operatively connected to communicate with the various vehicle systems 140 and/or individual components thereof. For example, returning to FIG. 1, the one or more processors 110 and/or the autonomous driving module(s) 160 can be in communication to send and/or receive information from the various vehicle systems 140 to control the movement, speed, maneuvering, heading, direction, etc. of the vehicle 100. The one or more processors 110 and/or the autonomous driving module(s) 160 may control some or all of these vehicle systems 140 and, thus, may be partially or fully autonomous.

The vehicle 100 can include one or more modules, at least some of which are described herein. The modules can be implemented as computer-readable program code that, when executed by a processor 110, implement one or more of the various processes described herein. The processor 110 can be a device, such as a CPU, which is capable of receiving and executing one or more threads of instructions for the purpose of performing a task. One or more of the modules can be a component of the one or more processors 110, or one or more of the modules can be executed on and/or distributed among other processing systems to which the one or more processors 110 is operatively connected. The modules can include instructions (e.g., program logic) executable by one or more processors 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

In some implementations, the vehicle 100 can include one or more autonomous driving modules 160. The autonomous driving module(s) 160 can be configured to receive data from the sensor system 120 and/or any other type of system capable of capturing information relating to the vehicle 100 and/or the external environment of the vehicle 100. In one or more arrangements, the autonomous driving module(s) 160 can use such data to generate one or more driving scene models. The autonomous driving module(s) 160 can determine the position and velocity of the vehicle 100. The autonomous driving module(s) 160 can determine the location of obstacles, or other environmental features including traffic signs, trees, shrubs, neighboring vehicles, pedestrians, etc.

The autonomous driving module(s) 160 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The autonomous driving module(s) 160 can be configured can be configured to implement determined driving maneuvers. The autonomous driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving module(s) 160 can be configured to execute various vehicle functions and/or to transmit data to, receive data from, interact with, and/or control the vehicle 100 or one or more systems thereof (e.g., one or more of vehicle systems 140). The noted functions and methods will become more apparent with a further discussion of the figures.

Detailed implementations are disclosed herein. However, it is to be understood that the disclosed implementations are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various implementations are shown in FIGS. 1-3, but the implementations are not limited to the illustrated structure or application.

The flowcharts and block diagrams in the figures illustrate the architecture, functionality, and operation of possible implementations of systems, methods, and computer program products according to various implementations. In this regard, each block in the flowcharts or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can be executed substantially concurrently, or the blocks can sometimes be executed in the reverse order, depending upon the functionality involved.

The systems, components and/or methods described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or methods also can be embedded in a computer-readable storage, such as a computer program product or other data programs storage device, readable by a machine, tangibly embodying a program of instructions executable by the machine to perform methods and methods described herein. These elements also can be embedded in an application product which comprises all the features enabling the implementation of the methods described herein and, which when loaded in a processing system, is able to carry out these methods.

Furthermore, arrangements described herein can take the form of a computer program product embodied in one or more computer-readable media having computer-readable program code embodied or embedded, such as stored thereon. Any combination of one or more computer-readable media can be utilized. The computer-readable medium can be a computer-readable signal medium or a computer-readable storage medium. The phrase “computer-readable storage medium” means a non-transitory storage medium. A computer-readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a RAM, a ROM, an EPROM or Flash memory, an optical fiber, a portable compact disc read-only memory (CD-ROM), a digital versatile disc (DVD), an optical storage device, a magnetic storage device, or any suitable combination of the foregoing. In the context of this document, a computer-readable storage medium can be any tangible medium that can contain, or store a program for use by, or in connection with, an instruction execution system, apparatus, or device.

Program code embodied on a computer-readable medium can be transmitted using any appropriate medium, including but not limited to wireless, wireline, optical fiber, cable, RF, etc., or any suitable combination of the foregoing. Computer program code for carrying out operations for aspects of the present arrangements can be written in any combination of one or more programming languages, including an object-oriented programming language such as Java™, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a LAN or a WAN, or the connection can be made to an external computer (for example, through the Internet using an Internet Service Provider).

In the description above, certain specific details are outlined in order to provide a thorough understanding of various implementations. However, one skilled in the art will understand that the invention may be practiced without these details. In other instances, well-known structures have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one or more implementations” or “an implementation” means that a particular feature, structure or characteristic described in connection with the implementation is included in at least one or more implementations. Thus, the appearances of the phrases “in one or more implementations” or “in an implementation” in various places throughout this specification are not necessarily all referring to the same implementation. Furthermore, the particular features, structures, or characteristics may be combined in any suitable manner in one or more implementations. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings (such as “Background” and “Summary”) and sub-headings used herein are intended only for general organization of topics within the present disclosure and are not intended to limit the disclosure of the technology or any aspect thereof. The recitation of multiple implementations having stated features is not intended to exclude other implementations having additional features, or other implementations incorporating different combinations of the stated features. As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an implementation can or may comprise certain elements or features does not exclude other implementations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an implementation or particular system is included in at least one or more implementations or aspect. The appearances of the phrase “in one aspect” (or variations thereof) are not necessarily referring to the same aspect or implementation. It should also be understood that the various method steps discussed herein do not have to be carried out in the same order as depicted, and not each method step is required in each aspect or implementation.

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one as or more than one. The term “plurality,” as used herein, is defined as two or more than two. The term “another,” as used herein, is defined as at least a second or more. The terms “including” and/or “having,” as used herein, are defined as including (i.e., open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC or ABC).

The preceding description of the implementations has been provided for purposes of illustration and description. It is not intended to be exhaustive or to limit the disclosure. Individual elements or features of a particular implementation are generally not limited to that particular implementation, but, where applicable, are interchangeable and can be used in a selected implementation, even if not specifically shown or described. The same may also be varied in many ways. Such variations should not be regarded as a departure from the disclosure, and all such modifications are intended to be included within the scope of the disclosure.

While the preceding is directed to implementations of the disclosed devices, systems, and methods, other and further implementations of the disclosed devices, systems, and methods can be devised without departing from the basic scope thereof. The scope thereof is determined by the claims that follow.

What is claimed is:

1. A system for obtaining roadside assistance, the system comprising:
one or more vehicle sensors;
one or more processors; and
a memory communicably coupled to the one or more processors and storing:
a detection module including instructions that when executed by the one or more processors cause the one or more processors to:
monitor sensor data from the one or more vehicle sensors; and
detect that a vehicle is in a disabled condition based, at least in part, on the monitored sensor data; and
a response module including instructions that when executed by the one or more processors cause the one or more processors to:
communicate automatically with a roadside assistance provider to request roadside assistance;
communicate automatically with a ridesharing service provider to request a rideshare vehicle;
receive roadside assistance availability data from the roadside assistance provider and ridesharing availability data from the ridesharing service provider; and
arrange automatically, with the ridesharing service provider, a pickup time for the rideshare vehicle based, at least in part, on an analysis of the roadside assistance availability data and the ridesharing availability data.

2. The system of claim 1, further comprising a vehicle-access module including instructions that when executed by the one or more processors cause the one or more processors to transmit, to the roadside assistance provider, a digital key providing temporary access to the vehicle, when the pickup time for the rideshare vehicle is prior to an estimated time of arrival of roadside assistance.

3. The system of claim 2, wherein the digital key expires a specified period of time after the roadside assistance provider receives the digital key.

4. The system of claim 2, wherein the digital key expires when an agent of the roadside assistance provider delivering the vehicle to a specified location after the vehicle has been serviced exits a predetermined geofence surrounding the specified location.

5. The system of claim 1, wherein the response module includes further instructions to ascertain an intended destination of the vehicle based on at least one of a destination input to a navigation system and a calendar entry in an electronic calendar of a user associated with the vehicle.

6. The system of claim 5, wherein the response module includes further instructions to specify, to the ridesharing service provider, the intended destination as a destination for the rideshare vehicle.

7. The system of claim 5, wherein the response module includes further instructions to send an automated notification to one or more meeting participants in the calendar entry.

8. The system of claim 1, further comprising:
a vehicle-access module including instructions that when executed by the one or more processors cause the one or more processors to transmit, to the roadside assistance provider, a digital key providing temporary access to a garage associated with a user of the vehicle to permit an agent of the roadside assistance provider delivering the vehicle after the vehicle has been serviced to park the vehicle inside the garage;
wherein the response module includes instructions to transmit an automated notification to the user of the vehicle, when the vehicle has been delivered.

9. The system of claim 1, wherein the response module includes further instructions to detect a number of occupants in the vehicle from the sensor data, and the instructions to communicate automatically with the ridesharing service provider to request the rideshare vehicle include instructions to request that the rideshare vehicle be of a type that accommodates the number of occupants in the vehicle.

10. The system of claim 1, wherein the detection module includes further instructions to report, to the roadside assistance provider, an extent of damage to the vehicle associated with the disabled condition based, at least in part, on the sensor data.

11. A non-transitory computer-readable medium for obtaining roadside assistance and storing instructions that when executed by one or more processors cause the one or more processors to:
monitor sensor data from one or more sensors in a vehicle;
detect that the vehicle is in a disabled condition based, at least in part, on the monitored sensor data;
communicate automatically with a roadside assistance provider to request roadside assistance;
communicate automatically with a ridesharing service provider to request a rideshare vehicle;
receive roadside assistance availability data from the roadside assistance provider and ridesharing availability data from the ridesharing service provider; and
arrange automatically, with the ridesharing service provider, a pickup time for the rideshare vehicle based, at least in part, on an analysis of the roadside assistance availability data and the ridesharing availability data.

12. The non-transitory computer-readable medium of claim 11, further comprising instructions to cause the one or more processors to transmit, to the roadside assistance provider, a digital key providing temporary access to the vehicle, when the pickup time for the rideshare vehicle is prior to an estimated time of arrival of roadside assistance.

13. A method of obtaining roadside assistance, the method comprising:
monitoring sensor data from one or more sensors in a vehicle;
detecting that the vehicle is in a disabled condition based, at least in part, on the monitored sensor data;
communicating automatically with a roadside assistance provider to request roadside assistance;
communicating automatically with a ridesharing service provider to request a rideshare vehicle;
receiving roadside assistance availability data from the roadside assistance provider and ridesharing availability data from the ridesharing service provider;
analyzing the roadside assistance availability data and the ridesharing availability data; and
arranging automatically, with the ridesharing service provider, a pickup time for the rideshare vehicle based, at least in part, on the analyzing the roadside assistance availability data and the ridesharing availability data.

14. The method of claim 13, further comprising transmitting, to the roadside assistance provider, a digital key providing temporary access to the vehicle, when the pickup time for the rideshare vehicle is prior to an estimated time of arrival of roadside assistance.

15. The method of claim 13, further comprising ascertaining an intended destination of the vehicle based on at least one of a destination input to a navigation system and a calendar entry in an electronic calendar of a user associated with the vehicle.

16. The method of claim 15, further comprising specifying, to the ridesharing service provider, the intended destination as a destination for the rideshare vehicle.

17. The method of claim 15, further comprising sending an automated notification to one or more meeting participants in the calendar entry.

18. The method of claim 13, further comprising:
transmitting, to the roadside assistance provider, a digital key providing temporary access to a garage associated with a user of the vehicle to permit an agent of the roadside assistance provider delivering the vehicle after the vehicle has been serviced to park the vehicle inside the garage; and
transmitting an automated notification to the user of the vehicle, when the vehicle has been delivered.

19. The method of claim 13, further comprising:
detecting a number of occupants in the vehicle from the sensor data;
wherein communicating automatically with the ridesharing service provider to request the rideshare vehicle includes requesting that the rideshare vehicle be of a type that accommodates the number of occupants in the vehicle.

20. The method of claim 13, further comprising:
reporting, to the roadside assistance provider, an extent of damage to the vehicle associated with the disabled condition based, at least in part, on the sensor data.
